(19) United States
(12) Patent Application Publication
(10) Pub. No.: US 2010/0151251 A1
(43) Pub. Date: Jun. 17, 2010

(54) METHOD AND PLANT FOR THE PRODUCTION OF MEMBRANE BODIES

(75) Inventors: PeirCarlo MOLTA, Prato (IT); Davide Innocenti, Florence (IT)

Correspondence Address: ABELMAN, FRAYNE & SCHWAB, 666 THIRD AVENUE, 10TH FLOOR, NEW YORK, NY, 10017, US

(73) Assignee: VELERIA MARCO HOLM S.R.L., Campi Bisenzio (IT)

(21) Appl. No.: 12/451,733

(22) PCT Filed: May 23, 2008
(86) PCT No.: PCT/IT2008/000345

§ 371 Date: Feb. 25, 2010

(30) Foreign Application Priority Data
May 24, 2007 (IT) RA2007A000041

(51) Int. Cl. B32B 1/00; B32B 37/02

(52) U.S. Cl. 428/411.1; 156/245; 156/500; 156/379.6

(57) ABSTRACT

A method and a plant (1) for the production of a membrane body (10) that is flexible and able to assume a given shape under load; the membrane body being provided with at least one pair of flexible sheets (9) mutually coupled through an adhesive layer (14) positioned between mutually facing respective faces (16) of the sheets (9); the method comprising a step of die casting a portion (11) of given extension of the membrane body (10) to determine adhesion between the faces (16) and to form at least one sheath (22) with an external tubular portion of a respective cable (20); the step of die casting the portion (11) being achievable by thermal activation of the adhesive layer (14) in a static manner.

### BACKGROUND OF THE INVENTION

1. Field of the Invention

The present invention relates to a method and to a plant for the production of membrane bodies. In particular, the present invention relates to a method and a plant for the production of membrane bodies provided with panels reinforced by cables housed within sheaths. In more detail, the present invention relates to a method and a plant for the production of membrane bodies provided with panels reinforced by cables housed within sheaths through a succession of steps of gluing, thermal activation and application of pressure.

2. Description of the Prior Art

In the fields of sails for boats and of coverings to be used in civil constructions, the use is known of membrane bodies made of flexible material and able to assume, once they are subjected to traction in correspondence of given points, shapes that are predetermined during the design. Normally, these membrane bodies can be produced by assembling together a plurality of panels, or sailclothes, appropriately shaped and coupled by means of respective edges. This assembly operation is normally performed by stitching or by gluing. In some cases, and normally every time it is necessary to produce membrane bodies that present curved shapes and reduced mass, cables are normally applied to the panels along given force lines. These cables can be applied by gluing from the exterior or they can be incorporated within the sailclothes and then inserted between two foils coupled adhesively when constructing each individual sailcloth. This enables to strengthen, for equal mass, the membrane bodies themselves, to reduce both gravitational and tensional stresses on load-bearing structures, in such a way as to enable to streamline these structures, to simplify the installation and maintenance of the membrane bodies, to use tensioning devices of smaller capacity.

There are multiple examples of membrane bodies produced in this way. The first teachings in this sense are attributed to Horizon—Performance Sails, a US-based sail maker that as early as September 1985 had marketed sails with the technology called Tape Drive, which enabled to build sails reinforced with uninterrupted load bearing yarns made of Kevlar applied through an adhesive connection; this technology was subsequently transferred to the US sail maker Ulmer & Kolius. On the other hand, it is worth recalling some patents relating to sails for the propulsion of boats, among which the U.S. Pat. No. 4,593,639, held by the US company SOBSTAD SAILMAKERS INC., the U.S. Pat. No. 5,097,784 of the US company NORTH SAILS GROUP, INC. that have already been discussed in Italian patent application no. RA2004A000004 by the applicant, whose teachings and terminology indications are considered, for the sake of continuity and convenience, to be integral parts of the present description. It should simply be noted that sails are particular membrane bodies that serve their propelling function once they are hoisted and made substantially rigid under load to assume a given aerodynamic conformation.

On the other hand, the membrane bodies must also be very flexible to be adjustable in such a way as to assume different shapes according to the different conditions of the wind, of the sea and of the tack to be maintained.

According to the teachings of the aforementioned application '004, each sailcloth comprises cables housed between two panels coupled in an adhesive manner when constructing each individual sailcloth through the interposition of a sheath, in such a way as to be free to slide longitudinally to maximise the flexibility of the membrane body between an adjustment and the other, and hence during installation, adjustment, removal and storage.

The activation of the adhesive that keeps the panels coupled and that determines the maintenance of the correct position of the cables occurs by delivery of heat and naturally the technologies employed to manufacture the sails according to the teachings of the U.S. Pat. Nos. 4,593,639 and 5,097,784 are not adequate to manufacture the membrane bodies described with reference to the application '004.

In any case, with reference to the delivery of the heat necessary for the activation of the adhesive layer that stably connects the two panels of each sailcloth to each other, it should be specified that, in some cases, this step is carried out by using rolling mills provide with pressing rollers heated to high temperature that can deliver heat even at 230° C., or by using infrared lamps that are carried movable throughout the surface of the sail. In the first case, the pressure and temperature are applied for limited times on each individual transverse segment of each sailcloth, whereas in the second case the temperature is cyclically applied to each segment of the sail. In particular, the pressure is applied dynamically and on segments of sailcloth delimited by sides whose dimensions are of distinct orders of magnitude, given the limited extension of the segment normal to the rollers. In particular, in the case of roller lamination the permanence of each individual transverse segment of the sail under the rollers under pressure is in the order of tenths of seconds. Therefore, in both cases, each semi-manufactured product is dynamically subjected to at least one succession of heating and cooling that cannot avoid giving heterogeneous characteristics to adjacent segments of the sailcloths of the sail, and hence also globally to the sail, which can therefore present different abilities to withstand the loads acting in use according to proportions that are difficult to determine a priori. Naturally, this is a function of the speed with which the cycle is repeated locally; in any case, the result is to have a final product whose quality can certainly be improved.

In view of the situation described above, it would be desirable to have available a method for the production of membrane bodies that, in addition to allowing to limit and possibly to overcome the typical drawbacks of the prior art illustrated above, can define a new production standard applicable at contained costs through production plants which can be constructed with low investment level.

### SUMMARY OF THE INVENTION

The present invention relates to a method and plant for the production of membrane bodies. In particular, the present invention relates to a method and a plant for the production of membrane bodies provided with panels reinforced by cables housed within sheathes. More in detail, the present invention relates to a method and to a plant for the production of membrane bodies provided with panels reinforced by cables housed within sheaths through a succession of steps of gluing, thermal activation and application of pressure.

An object of the present invention is to provide a method for the production of a membrane body that is free of the drawbacks illustrated above, that is able to allow to maintain and improve the characteristics of the product as a result of an optimisation of energy consumption and of production times with a minimal use of human resources and that can be implemented through a plant that is particularly simple and economical.

According to the present invention, a method for the production of a membrane body is provided, whose main characteristics are described in at least one of the appended claims.

A further object of the present invention is to provide a plant for production of a membrane body that is free of the drawbacks illustrated above, that is able to provide the membrane bodies with high performance characteristics through equipment that is particularly simple, economical and easy to use, whereto correspond reduced energy consumption and production times according to high safety standards, in such a way as to propose to the market products of low cost but with high performance characteristics and reduced mass.

According to the present invention, a plant for the production of a membrane body is obtained that is free of the drawbacks illustrated above.

A further object of the present invention is to provide at least one device for the production of membrane bodies that is usable in a plant for the production of a membrane body to facilitate the application of the method described above.

According to the present invention, a device for the production of membrane bodies is also obtained, whose characteristics shall be described in at least one of the appended claims.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

In the drawings: . . .

Further characteristics and advantages of the method, of the plant and of equipment of the plant for the production of membrane bodies according to the present invention shall become more readily apparent from the description below, set forth with reference to the accompanying drawings that illustrate some non limiting embodiment examples, in which identical or corresponding parts of the device are identified by the same reference numbers. In particular:

FIG. 1 is a schematic view of a plant for the application of the method according to the present invention;

FIG. 2 is a schematic plan view of membrane body which can be produced by means of the plant of FIG. 1;

FIG. 3 is a view of a portion of FIG. 2 sectioned according to the line III-III of FIG. 2 and illustrated in enlarged scale and with some parts removed for the sake of clarity;

FIG. 4 is a plan view of a portion of FIG. 2 shown in enlarged scale in association with a first equipment in a first operative step of the method according to the present invention;

FIG. 5 is a view of a portion of FIG. 4 sectioned according to the line V-V of FIG. 4 and illustrated in enlarged scale and with some parts removed for the sake of clarity;

FIG. 6 is a schematic plan view of an additional equipment of the plant of FIG. 1;

FIG. 7 is a view of FIG. 6 in a second operative step of the method according to the present invention;

FIG. 8 is a view in enlarged scale and with some parts removed for clarity of an angular portion of FIG. 7;

FIG. 9 is a view of a portion of FIG. 1 sectioned according to the line IX-IX of FIG. 1 and illustrated in enlarged scale and with some parts removed for the sake of clarity;

FIG. 10 is a plan view partly in sight and partly in section of a particular extracted from FIG. 1;

FIG. 11 is a schematic perspective view of a portion of FIG. 1 shown with some parts removed for clarity in a third operative step of the method according to the present invention; and

FIG. 12 is a plan view of a portion of FIG. 1 in a fourth operative step.

### DETAILED DESCRIPTION OF THE PREFERRED EMBODIMENT

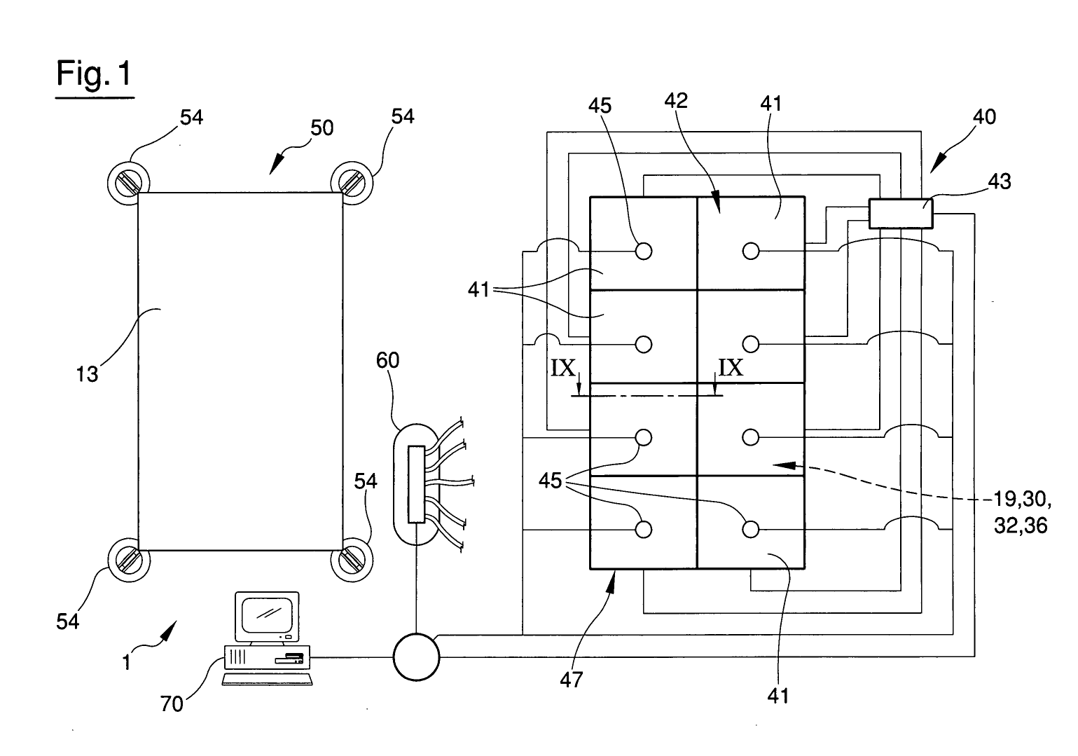

In FIG. 1, the reference number 1 indicates, in its entirety, a plant for the application of a method for producing flexible membrane bodies 10 that are able to assume a given shape under load, in such a way as to constitute, for example, an awning for civil uses, sometimes briefly called tensile structure, or the wing profile of a sail, usable for the propulsion of a boat or of an aircraft.

In any case, for the sake of convenience, and in order not to limit the scope of the present invention, the steps of the method are illustrated in the accompanying drawings with reference to the manufacturing cycle of a sail. Also for the sake of convenience, the reference numbers used with reference to the sail are the same employed with reference to the generic membrane body 10. The application of tension to the membrane bodies 10 when they are in place stretches their respective outer faces 17 and prevents the collection and stagnation of rainwater in the case of awnings, and optimises their aerodynamic efficiency in the case of wing profiles. Each membrane body 10 can be produced starting from basic sheets 9 made of plastic panels cut according to given lines to locate the so-called “fullness” of the respective membrane body 10 in given areas and hence to provide the membrane body with the desired profile. These sheets 9 are preferably, but without limitation, made of polyester, as in the case of Mylard produced by the Dupont Company, and they are coupled in pairs on respective transversal edges 9′ to produce a single laminar body 12 with given shape, which develops transversely to the edges; the laminar body 12 will be subsequently covered by a plurality of covering sheets, each of which is substantially identical to a respective base sheet 9 and therefore is always indicated with the same reference number 9; each covering sheet 9 copies the perimeter of the corresponding base sheet 9, is preferably made of polyester and it is connected stably thereto through an adhesive layer 14 applied between the respective inner faces 16 of the base and covering sheets 9 to produce a semi-manufactured product 2 wherefrom the membrane body 10 can be produced.

It should be specified that here and below, with reference to the description of the production method and/or of the plant 1 or of respective equipment, the terms membrane body 10 or semi-manufactured product 2 will be used as required by the context. Therefore, the elements and the related reference numbers used hitherto for the membrane body 10 are considered valid also to distinguish dual elements of the semi-manufactured product 2. On the other hand, it is readily apparent that the use of the term “membrane body” 10 in an intermediate step of the method shall be interpreted as semi-manufactured product 2, given that the membrane body 10 is the final product of the application of the method described hereafter. Moreover, it should be specified that in sea-faring terms, the term “fullness” defines the distance or camber between the cord and the segment detached on a membrane body 10 between two points of the membrane body 10. By analogy with the sail sector, each pair of base and covering sheets 9 coupled to each other in an adhesive manner shall, here and below, be called sailcloth 15 for the sake of convenience, although in the case of the membrane bodies 10 in question nothing structural may correspond to this term.

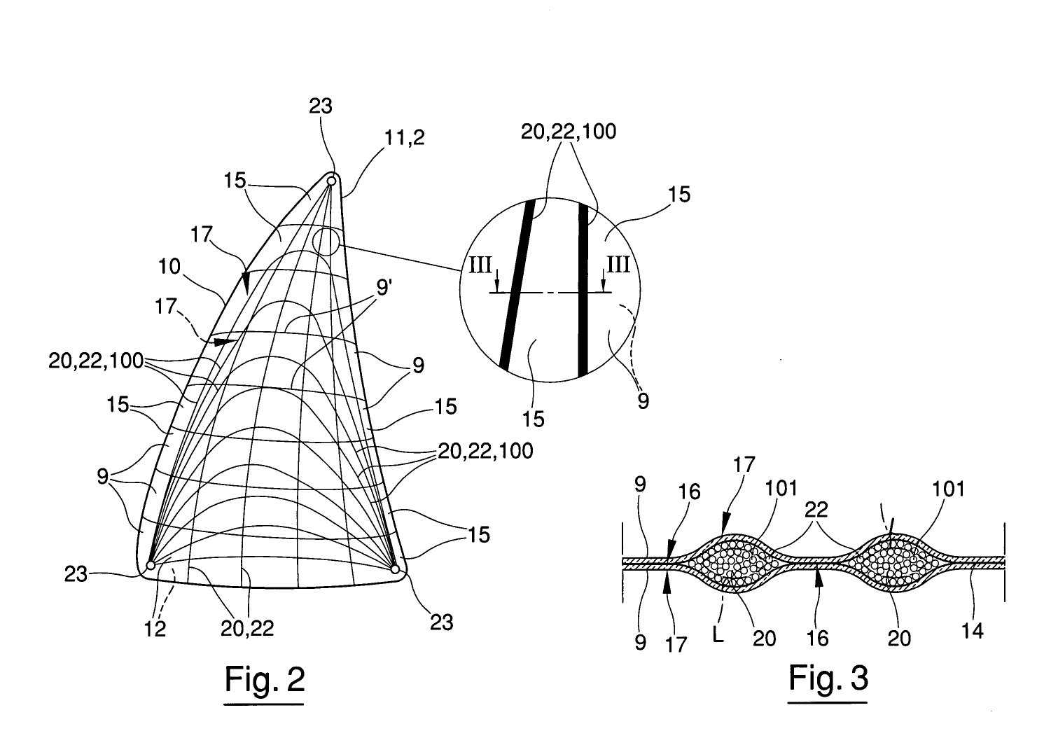

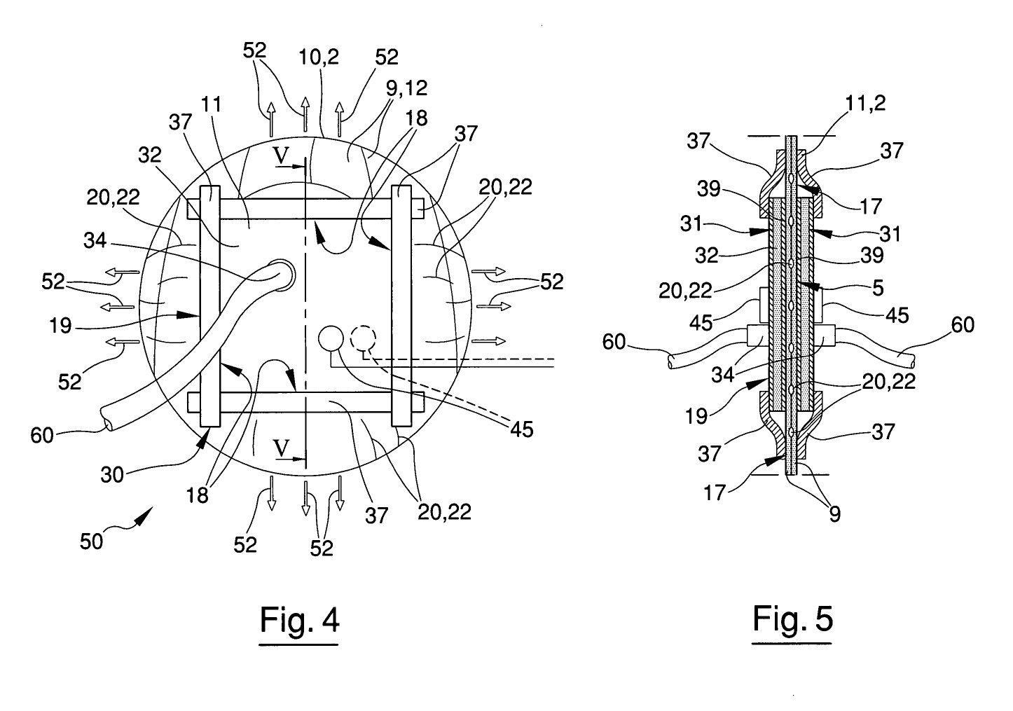

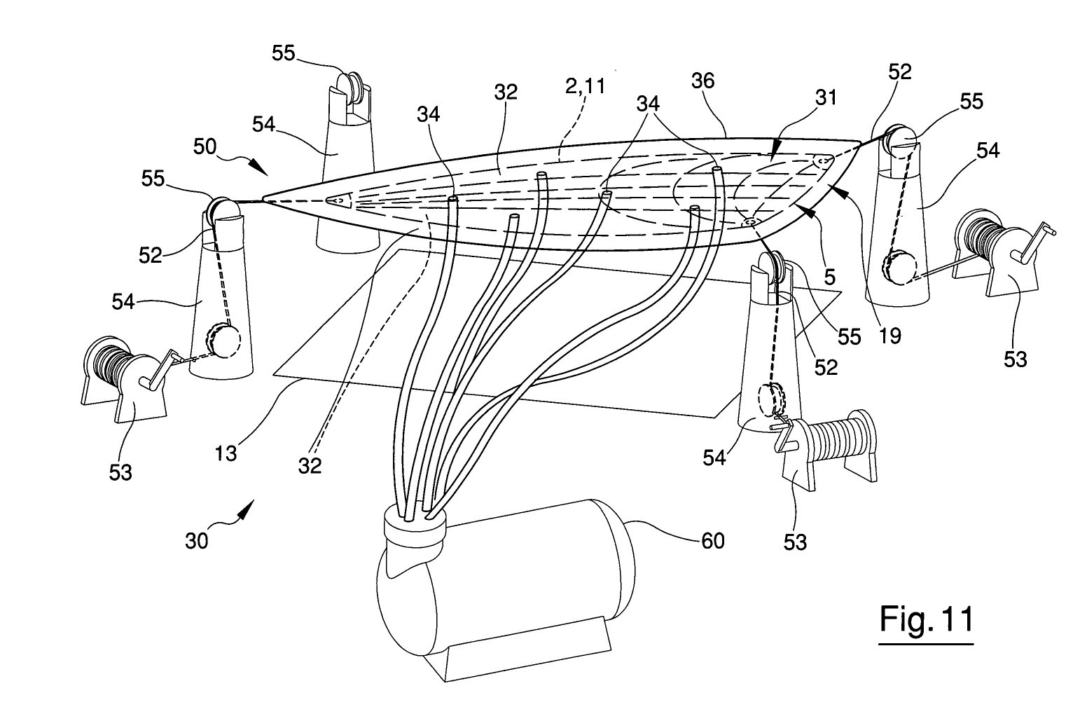

The better to withstand tensions in place, each membrane body 10 comprises at least one cable 20 housed along a given track 100 between the faces 16 opposite and connected to each other in an adhesive manner of pairs of base sheets 9 of each sailcloth 15 to maintain, in use, each sailcloth 15 substantially tension-free. It should be noted that each track 100 represents a line along which, in use, the traction force that stresses the membrane body 10 acts and that each cable 20 is free to slide relative to each sailcloth 15 since it is retained between the faces 16 within a sheath 22 in a manner similar to the operation of Bowden cables. Each sheath 22 is produced with an external tubular portion of the respective cable 20 during a die casting step that shall be better described below and determines, contextually, the adhesive connection of the opposing sheets 9 of each sailcloth 15. The incorporation of cables 20 enables to produce each individual sailcloth 15 using the laminar material of minimum thickness, and hence to obtain membrane bodies 10, whose mass is consequently reduced. An example of a membrane body 10 is described in the aforementioned patent application RA2004A000004, whose teachings are considered incorporated herein for the sake of simplicity. The plant 1 comprises a die casting device 30 visible in FIGS. 4, 5, 6, 7, 10 and 11. This device 30 can be used to execute some productive steps of a portion 11 of the semi-manufactured product 2 of the membrane body 10, and it presents limited extension, as shown in FIGS. 2, 4, 7 and 11 only. The portion 11 may present different extension and be more or less extended. For example, it may comprise a portion of a sailcloth 15 or even portions of two or more sailcloths 15 set side by side. The device 30 comprises a pair of presser bodies 32 that are made of a flexible and heat permeable material to be able to be applied locally to each portion 11 of the membrane body 10 in matching contact to determine, in use, an openable sandwich structure 19, visible in FIGS. 5 and 11, which is thus a part of the device 30, as shall be further clarified below. Moreover, again with reference to FIG. 1, the plant 1 comprises a device 40 for the delivery of heat/thermal activation that presents at least one radiating plate 41 which can be activated electrically to deliver heat to a portion 11 of given extension maintained under vacuum between two presser bodies 32, and hence usable to activate the adhesive layer 14 positioned between two faces 16 facing each other. The activation device 40 comprises a control unit 43 connected electrically to the plate 41 and adapted to provide instant by instant heat at a given temperature to the portion of given extension according to a given thermal cycle, which comprises a succession of heating and cooling controlled as a function of time, for example but without limitation according to the type of adhesive used for the preparation of the layers 14. In this regard, the control unit 43 is provided with a feedback control circuit 44, known and therefore not shown herein, whose operation is made possible by means of a plurality of respective temperature sensors 45, able to provide instant by instant the local value of the temperature of each presser body 32, and hence of the portion 11 whereto, in use, heat is delivered. In this regard, some sensors 45 may be applied indifferently to the plates 41 or to the body 32 which is placed in contact with at least one plate 41, and other sensors 45 shall be applied to the other body 32, in such a way as to enable to reconstruct the trend of the thermal gradient within the membrane body 10 being processed, given the knowledge obtainable from design data of the assembly that comprises the two presser bodies 32 and the portion 11 of membrane body 10 maintained between them.

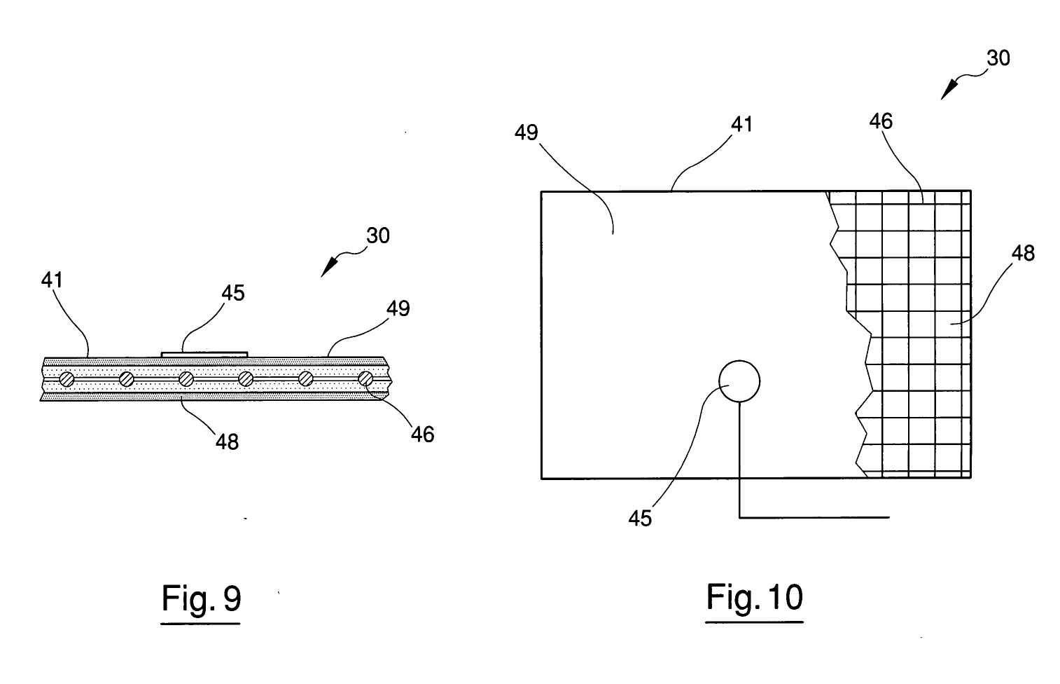

As shown in FIGS. 9 and 10, each plate 41 is adapted to deliver heat at a homogeneous temperature over the entire respective extension and it enables to obtain this result through the combination of a grid 46 of conductive material kept isolated from the floor by a layer 48 of insulating material, and covered by a foil 49 of metallic material with low thermal inertia, for example, although without limitation, aluminium or an alloy thereof. The device 40 is able to co-operate with at least one body 32 to determine a heat adhesion between the mutually opposite faces 16 of each pair of sheets 9 and the formation of the sheaths 22 with an external tubular portion of each cable 20, produced using, preferably but without limitation, rowing 101 of free fibres. To each body 32 is associated at least one aspirating element 34 whereby it is possible to aspirate air from a gap 5 between the portion of given extension of the membrane body 10 and each body 32, to determine the adhesion between the mutually facing faces 16 of each pair of sheets 9/sailcloth 15, and to enable to dose the value of the pressure acting transversely of each portion 11 during the die casting operation, exploiting the flexibility of the presser body 32 itself. Naturally, the density per unit of surface of aspirating elements 34 shall be calibrated in relation to requirements, and in particular to the rate of vacuum, and hence of pressure to be applied to the faces 17 of the semi-manufactured product 2.

The plant 1 further comprises a loading device 50 able to reproduce a tension model similar to the one that, in operation, acts at least on the portion 11, as shown in FIG. 4. In this regard, this device 50 comprises traction elements 52 provided in association with lateral edges 18 of the portion 11 of given extension to be treated with die casting in order to keep it stretched with the expected distribution of fullness, i.e. free of creases to obtain the effects described above in such a way as to simulate an operating condition for the portion 11. In FIG. 4, for the sake of simplicity of representation, said traction elements 52 are illustrated schematically through the respective traction lines that act in opposite senses on mutually orthogonal directions. The availability of the loading device 50 and of the elements 52 enables to couple the bodies 32 to the faces 17 in a mating manner and to obtain the direct transmission of heat from the plates 41 to the involved portion of the semi-manufactured product 2 to obtain the complete activation of the layer 14 between the sheets 9 and the formation of the sheaths 22. In practice, the elements 52 may be embodied by cables made of textile fibre which shall in any case be designated by the same reference number 52.

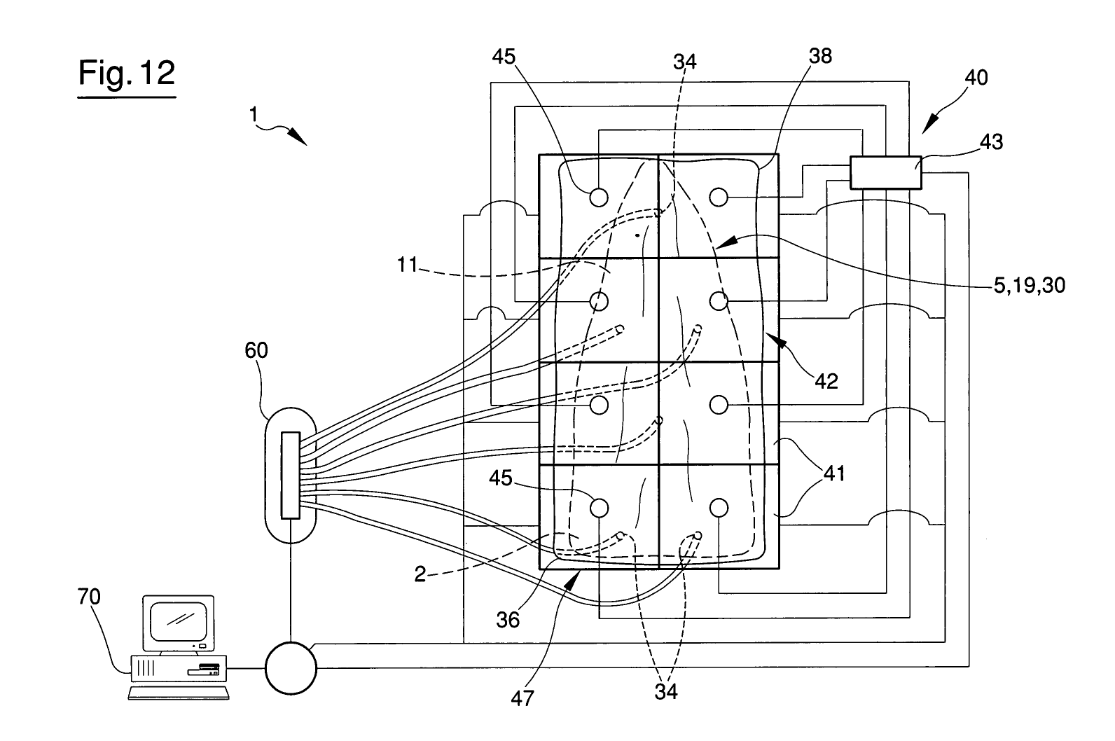

Naturally, what is described above finds valid application also if the extension of the portion 11 is such as to completely include the membrane body 10 itself. In this case, the same reference numbers will be used to indicate devices, members and elements of the membrane 10 already employed and also those already mentioned with reference to the portion 11 described above. The delivery of heat to each presser body 32 can take place by conduction once one of the two presser bodies 32 that cover the portion 11 is placed in contact with at least one plate 41. In view of the above description, only one outer face of the portion 11, or of the membrane body 10 as needed, faces a plate 41, hence the source of heat that induces the activation of the adhesive layer 14. The need to follow the shape of the membrane body 10 by the bodies 32 could determine undulations of the sandwich structure comprising the two presser bodies 32 and the portion 11 covered thereby if the latter were very extensive, because of the coupling of the same portion 11 provided with the related “fullness” with flexible but planar pressers. In this case, the die casting temperature could have spotted patterns, whereto would correspond different qualities of the die casting operation itself. To obtain a homogeneous quality of the die casting in each point of the membrane body 10 and a complete formation of the sheaths 22, the die casting device 30 comprises a coating body 38, shown only in FIG. 12 and obtainable with a sheet produced with material having high insulating capacity. This body 38, therefore, is flexible to cover the undulations of the sandwich structure 19 in substantially mating manner by gravity. This prevents an excessive temperature gradient between the outer faces 17 of the semi-manufactured product 2/of the membrane body 10, and it prevents the temperature difference from exceeding a given value that approximates 5° C.÷10° C. It should be specified that the coating body 38 could comprise internally a plurality of electrical resistors, known and therefore not shown, to be electrically heated in substantially identical manner to an electric heating blanket; therefore, the body 38 can be interpreted as a device for the production of heat at given temperature, to be used in combination or alternatively to the radiating plates 41, in order to minimise, in use, the temperature gradient between two presser bodies 32 that face each other and hence the corresponding portion of the membrane body 10. In any case, the expected effect of the application of the body 38, whether or not it is complemented with a device for producing heat, will be to minimise the differences between the external temperatures of the bodies 32 positioned at opposite sides of a same portion 11 within 5° C.÷10° C.

Obviously, the method described above can also be used to rework portions 11 of the membrane body 10 whose sheets are locally detached at the end of the heating operation or as a result of even limited use.

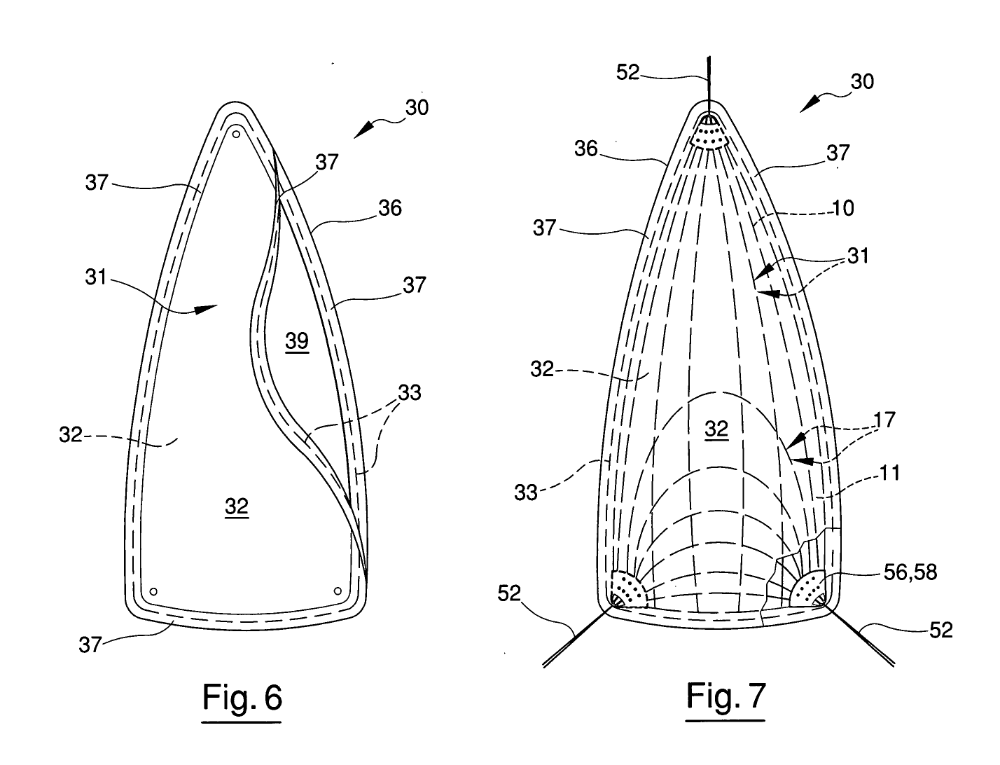

It is also evident that, if the portion 11 extends substantially as much as the entire membrane body 10, each body 32 will have to present sufficiently extensive dimensions to cover all the sailcloths 15 of the membrane body 10 itself. In such cases it may be convenient to connect the bodies 32 on respective sides 33 with adequate extension to define a pouch body 36, visible in FIGS. 6 and 7, associated to the device 30 and adapted integrally to house within its interior a membrane body 10; therefore, the body 36 is able completely to cover each of the mutually opposite faces 17 that delimit the membrane body 10. This also simplifies the formation of the sandwich structure 19 thanks to the greater ease with which a depression/a pneumatic vacuum can be produced between an inner body of the body 36, or of the body 32, and the corresponding portion of membrane body 10 that faces it. Preferably, although without limitation, it may be convenient to use strips 37 of repositionable adhesive tape to hermetically close the sides 33 of the presser bodies 32 left open by the insertion of the semi-manufactured product 2 to be subjected to die casting. This would enable completely to isolate from the exterior said semi-manufactured product 2 housed within the body 36 and to make the body 36 indefinitely reusable.

If should be specified that the load device 50 also comprises uprights 54 with height adjustable at will to allow the detachment from the ground, by lifting, of a membrane body 10 through at least one cable 52. In this regard, each upright 54 is provided with at least one pulley 55 in a respective free end for a cable 52 and it can be associated to a retrieval device 53 for the excess segment of the cable 52. The device 50 further comprises engagement members 56 each of which is so shaped as to grip the clews/angular portions 23 of the membrane body 10, and it is provided with at least one eyelet 57 engageable by a cable 52 for the application of the traction, and hence lifting load, to be applied to the membrane body 10 to cause a sort of stretching of the semi-manufactured product 2. Each member 56 presents two jaws 58 that are mutually connected through threaded members to establish a rigid contact with the respective clew 23 and they internally present projections 59 able superficially to indent the material/the skin of each laminar body 12 to stabilise the grip of the respective clew 23 and hence the position of the eyelet 57 during the application of the load through the cables 52.

The application of the load enables to stretch any creases of the semi-manufactured product 2 within the pouch body 36 and, in view of the above description, it can be accomplished through the device 50 in an equipped space with limited height and extension under the simple action of gravity. During this step of stretching the semi-manufactured product 2, each body 34 is used to produce vacuum, in such a way as to refer in stable manner the pouch body 36 with respect to the semi-manufactured product 2 and to ready the body 36 itself to the application of the desired pressure on the semi-manufactured product 2. Once the semi-manufactured product 2 is completely stretched within the respective body 36 through the traction exerted by the cables 52, the stably connected assembly of the completely stretched semi-manufactured product 2 and of the pouch body 36 that keeps it tight between two respective spacer bodies 39 may be lowered above the plates 41 to proceed with the delivery of the heat necessary to activate the adhesive layer 14.

Therefore, the device 50 for loading the plant 1 can easily be set up inside an industrial shed of average dimensions and with affordable costs even for small enterprises. In addition, it should be specified that this solution enables to apply to the semi-manufactured product 2 a tension that is well below its breaking tension, and hence to preserve its physical integrity at every step of the production cycle, since the tension whereto the respective peripheral sides are subjected to assure the flattening of the surfaces 17 of the membrane body 10 is markedly lower than the operating tension.

The plant 1, moreover, comprises an aspirating unit 60 coupled in a fluid-tight manner with each aspirating member 34 to generate, in use, a vacuum between each sheet 9 and each respective presser body 32 or pouch body 36. In particular, each presser body 32/pouch body 36 is externally delimited by an air-impermeable coating 31 and it is provided internally with the spacer body 39 which is flexible to take mating contact with the membrane body 10 and to maintain a gap 5 of minimum thickness between the impermeable coating 31 and the portion 11 or the membrane body 10, based on the extension of the portion of layer 14 of adhesive to be subjected to die casting. As is readily apparent, the gap 5 is completely engaged by the body 39, which is made of felt or of another structurally similar material, and hence porous, to present sufficient height to maintain, in use, the aspirating members 34 in aerial communication with the interior of each body 32, in addition to allow relative movements between the membrane body 10 and the pouch body 36, which may be necessary for stretching the surfaces 17 before the full activation of the aspirating device 60, and for aspirating the residual air. It should be noted that, again according to FIG. 1, the plant 1 comprises an electronic computer 70 whereto are connected the aspirating unit 60, the temperature sensors 45 and the control unit 43 to globally oversee the operating modes of the plant 1.

Use of the plant 1 will be more readily apparent from the description that follows, from which it will be possibly punctually to deduce the steps of the method for the production of a membrane body to be used as wing profile and hence of a sail 10.

For the sake of brevity, the steps of the method 20 in question are illustrated starting from the step in which the semi-manufactured product 2 has already been completed.

At this point, the semi-manufactured product 2 is locally or integrally subjected to the die casting step by application of a constant pressure on its own faces 17 and hence on a portion 11 of given extension either on its entire surface through pairs of presser bodies 32, or through the entire pouch body 36, through the openable/temporary sandwich structure 19, and for the simultaneous delivery of heat 5, necessary for the activation of the layer 14. If the die casting has to be limited to a portion 11 of given extension of the semi-manufactured product 2, the application of tension may be limited only to the portion 11 involved, in order to stretch it perfectly, respecting the spatial distribution of its fullness in order to provide the portion 11 with substantially identical shape to the one it will have when installed; any creases are eliminated from the two bodies 32 and adhesive strips 37 are applied to the edges of the bodies 32 to connect them stably and in an air-tight manner to the respective faces 17 in such a way as to stabilise the openable sandwich structure which comprises two bodies 32 and the portion 11 included between them. Subsequently a body 32 is locally applied which approximates by excess the extension of the portion 11 to be treated on each of the respective outer faces 17. At this point, air is aspirated through each aspirating member 34 of each body 32 through the aspirating unit 60 until determining the application of a substantially homogeneous pressure on the two faces 17 of the portion 11. The next production step is to cause the activation of the adhesive layer 14 in such a way as to determine the permanent connection of the two laminar bodies 12 at the portion 11 and at the sheaths 22 with an external tubular portion of each rowing 101 of free fibres, and in particular with the portion imbibed with adhesive of the layer 14 which, for clarity of representation, in FIG. 3 is shown separated from the free fibres by a dashed and dotted line indicated by the letter L. The delivery of heat is executed activating as many plates 41 as are required by the extension of the portion 11 and hence it is necessary to position the portion 11 above each of these plates 41 which will be brought to temperature according to a thermal cycle set through the control unit 43. If the temperature gradient between the two bodies 32 has to be minimised below a given temperature, the upper body 32, opposite to the one placed in contact with the plate 41, should be covered completely with a coating body 38 with greater extension than the portion 11 itself for heat insulation according to the procedures described above. Naturally, the heat delivery step may be associated to the step of aspirating air from the gaps 5. The unit 60 may be controlled with feedback to measure with continuity the value of pressure within the gaps 5. This will allow to provide operators with information on the way the die casting operation proceeds, in order to enable them to decide whether to continue it and whether, the value of the vacuum remaining outside an optimal range for the type of adhesive used for the layer 14, the operation should be continued or executed anew, e.g. after remedying any detachments of the strips 37, or the replacement of at least one of the bodies 32, e.g. because of the loss of continuity of its coating 31 impermeable to air. Naturally, if the portion 11 coincides with the semi-manufactured product 2, it would be easy to use the pouch body 36 described above, and operate similarly to the above description. It is certain that it could be less easy to stretch the semi-manufactured product 2 within the body 36 if the semi-manufactured product 2 is very large. In this case, the application of the vacuum through the unit 60 is preceded by a step of lifting by the respective ends the semi-manufactured product 2, already contained by the body 36 not yet sealed and maintained at lower than atmospheric pressure, through the cables 52 borne/transmitted by the uprights 54 of the loading device 50 and connected securely to end portions of the semi-manufactured product 2 provided with the appropriate eyelets, exploiting the force of gravity to provide the semi-manufactured product 2 with the shape that the sail 10/the membrane body 10 originated by the die casting operation shall assume when installed. The subsequent hermetic closure of the pouch body 36, and the fact that each respective body 32 is flexible, will enable to bring in mating contact the inner face of the corresponding spacer body 39 with the respective laminar body 12 to allow maintaining a gap 5 between the impermeable coating 31 and the portion 11/the membrane body 10 to be laminated. In this case as well, the pressure decrease will have to take place slowly through the unit 60, to enable operators to intervene to stretch locally any creases of the bodies 32 on the semi-manufactured product 2. If the portion 11 coincides with the semi-manufactured product 2, it will be necessary to have available a furnace 47 comprising a continuous distribution of plates 41 and a coating body 38 of adequate dimensions, but this would not represent a variant of what is described above with reference to a portion 11 of limited extension.

Once the value of the vacuum is equal to the desired one, the membrane body may be lowered onto the plates 41 of the furnace 47, and to deliver heat to the presser bodies 32/to the pouch body 36 to perform the static die casting of the semi-manufactured product 2/membrane body 10, which will be kept at a given value of pressure and value of temperature for an adequate time interval, and subsequently cooled in a controlled manner to optimise the characteristics of the gluing and maximise the quality of the membrane body 10.

Lastly, it is readily apparent that the plant 1 and the method that can be implemented through said plant, and the accessories of the plant itself, can be subjected to modifications without however departing from the protective scope of the present invention.

For example, in the case of particularly important application, one may think of using pouch bodies 36 shaped like the membrane body 10 that has to be housed thereby for the die casting operation. Consistently with said approach, one could think of defining a radiant surface with sufficient extension and/or conformation to replicate substantially in negative form the dimension and/or the shape that shall be attributed to the membrane body 10 by coupling a plurality of plates 41 laterally to each other.

In any case, the set of the plates 41 can be interpreted as a sort of open furnace 47 able to house the pouch body 36 in order to subject the membrane body 10 to die casting treatment in association with the aspirating unit 60.

In view of the above description, it is readily apparent that implementation of the method through the plant 1 enables to produce membrane bodies 10 at very low energy consumption levels and production times, employing a minimum number of human resources with ordinary specialisation and through a particularly simple and economical plant. In particular, it should be noted that the prior art contains no teachings that would suggest using static die casting on a horizontal plane 13 to produce flexible membrane bodies through an openable sandwich structure 19. On the other hand, it makes no difference whether the die casting step takes occurs statically on the furnace 47 itself through the use of a sandwich structure 19 with limited extension or otherwise relative to the dimension of the membrane body 10, provided that one operates on a plane 42 comprising at least one of the planar plates 41 and thermally insulated in a very simple and economical manner through the simple coverage by gravity of a flexible body 38. In view of the above description, it is also possible to perform die casting treatments on portions 11 delimited by triangular perimeters, and anyway on two-dimensional segments presenting dimensions that, measured along respectively perpendicular directions, present lengths of the same order of magnitude, contrary to what takes place in rolling mills.

Therefore, it will not be surprising that through the implementation of the method and the plant 1 illustrated above it is possible to produce membrane bodies 10 with low cost but high performance characteristics and reduced mass.

### BACKGROUND TO THE INVENTION

In the fields of sails for boats and of coverings to be used in civil constructions, the use is known of membrane bodies made of flexible material and able to assume, once they are subjected to traction in correspondence of given points, shapes that are predetermined during the design. Normally, these membrane bodies can be produced by assembling together a plurality of panels, or sailclothes, appropriately shaped and coupled by means of respective edges. This assembly operation is normally performed by stitching or by gluing. In some cases, and normally every time it is necessary to produce membrane bodies that present curved shapes and reduced mass, cables are normally applied to the panels along given force lines. These cables can be applied by gluing from the exterior or they can be incorporated within the sailclothes and then inserted between two foils coupled adhesively when constructing each individual sailcloth. This enables to strengthen, for equal mass, the membrane bodies themselves, to reduce both gravitational and tensional stresses on load-bearing structures, in such a way as to enable to streamline these structures, to simplify the installation and maintenance of the membrane bodies, to use tensioning devices of smaller capacity.

There are multiple examples of membrane bodies produced in this way. The first teachings in this sense are attributed to Horizon—Performance Sails, a US-based sail maker that as early as September 1985 had marketed sails with the technology called Tape Drive, which enabled to build sails reinforced with uninterrupted load bearing yarns made of Kevlar applied through an adhesive connection; this technology was subsequently transferred to the US sail maker Ulmer & Kolius. On the other hand, it is worth recalling some patents relating to sails for the propulsion of boats, among which the U.S. Pat. No. 4,593,639, held by the US company SOBSTAD SAILMAKERS INC., the U.S. Pat. No. 5,097,784 of the US company NORTH SAILS GROUP, INC. that have already been discussed in Italian patent application no. RA2004A000004 by the applicant, whose teachings and terminology indications are considered, for the sake of continuity and convenience, to be integral parts of the present description. It should simply be noted that sails are particular membrane bodies that serve their propelling function once they are hoisted and made substantially rigid under load to assume a given aerodynamic conformation.

On the other hand, the membrane bodies must also be very flexible to be adjustable in such a way as to assume different shapes according to the different conditions of the wind, of the sea and of the tack to be maintained.

According to the teachings of the aforementioned application '004, each sailcloth comprises cables housed between two panels coupled in an adhesive manner when constructing each individual sailcloth through the interposition of a sheath, in such a way as to be free to slide longitudinally to maximise the flexibility of the membrane body between an adjustment and the other, and hence during installation, adjustment, removal and storage.

The activation of the adhesive that keeps the panels coupled and that determines the maintenance of the correct position of the cables occurs by delivery of heat and naturally the technologies employed to manufacture the sails according to the teachings of the U.S. Pat. Nos. 4,593,639 and 5,097,784 are not adequate to manufacture the membrane bodies described with reference to the application '004.

In any case, with reference to the delivery of the heat necessary for the activation of the adhesive layer that stably connects the two panels of each sailcloth to each other, it should be specified that, in some cases, this step is carried out by using rolling mills provide with pressing rollers heated to high temperature that can deliver heat even at 230° C., or by using infrared lamps that are carried movable throughout the surface of the sail. In the first case, the pressure and temperature are applied for limited times on each individual transverse segment of each sailcloth, whereas in the second case the temperature is cyclically applied to each segment of the sail. In particular, the pressure is applied dynamically and on segments of sailcloth delimited by sides whose dimensions are of distinct orders of magnitude, given the limited extension of the segment normal to the rollers. In particular, in the case of roller lamination the permanence of each individual transverse segment of the sail under the rollers under pressure is in the order of tenths of seconds. Therefore, in both cases, each semi-manufactured product is dynamically subjected to at least one succession of heating and cooling that cannot avoid giving heterogeneous characteristics to adjacent segments of the sailcloths of the sail, and hence also globally to the sail, which can therefore present different abilities to withstand the loads acting in use according to proportions that are difficult to determine a priori. Naturally, this is a function of the speed with which the cycle is repeated locally; in any case, the result is to have a final product whose quality can certainly be improved.

In view of the situation described above, it would be desirable to have available a method for the production of membrane bodies that, in addition to allowing to limit and possibly to overcome the typical drawbacks of the prior art illustrated above, can define a new production standard applicable at contained costs through production plants which can be constructed with low investment level.

### BACKGROUND TO THE INVENTION

The present invention relates to a method and plant for the production of membrane bodies. In particular, the present invention relates to a method and a plant for the production of membrane bodies provided with panels reinforced by cables housed within sheathes. More in detail, the present invention relates to a method and to a plant for the production of membrane bodies provided with panels reinforced by cables housed within sheaths through a succession of steps of gluing, thermal activation and application of pressure.

An object of the present invention is to provide a method for the production of a membrane body that is free of the drawbacks illustrated above, that is able to allow to maintain and improve the characteristics of the product as a result of an optimisation of energy consumption and of production times with a minimal use of human resources and that can be implemented through a plant that is particularly simple and economical.

According to the present invention, a method for the production of a membrane body is provided, whose main characteristics are described in at least one of the appended claims.

A further object of the present invention is to provide a plant for production of a membrane body that is free of the drawbacks illustrated above, that is able to provide the membrane bodies with high performance characteristics through equipment that is particularly simple, economical and easy to use, whereto correspond reduced energy consumption and production times according to high safety standards, in such a way as to propose to the market products of low cost but with high performance characteristics and reduced mass.

According to the present invention, a plant for the production of a membrane body is obtained that is free of the drawbacks illustrated above.

A further object of the present invention is to provide at least one device for the production of membrane bodies that is usable in a plant for the production of a membrane body to facilitate the application of the method described above.

According to the present invention, a device for the production of membrane bodies is also obtained, whose characteristics shall be described in at least one of the appended claims.

### BRIEF DESCRIPTION OF THE DRAWINGS

Further characteristics and advantages of the method, of the plant and of equipment of the plant for the production of membrane bodies according to the present invention shall become more readily apparent from the description below, set forth with reference to the accompanying drawings that illustrate some non limiting embodiment examples, in which identical or corresponding parts of the device are identified by the same reference numbers. In particular:

FIG. 1 is a schematic view of a plant for the application of the method according to the present invention;

FIG. 2 is a schematic plan view of membrane body which can be produced by means of the plant of FIG. 1;

FIG. 3 is a view of a portion of FIG. 2 sectioned according to the line of FIG. 2 and illustrated in enlarged scale and with some parts removed for the sake of clarity;

FIG. 4 is a plan view of a portion of FIG. 2 shown in enlarged scale in association with a first equipment in a first operative step of the method according to the present invention;

FIG. 5 is a view of a portion of FIG. 4 sectioned according to the line V-V of FIG. 4 and illustrated in enlarged scale and with some parts removed for the sake of clarity;

FIG. 6 is a schematic plan view of an additional equipment of the plant of FIG. 1;

FIG. 7 is a view of FIG. 6 in a second operative step of the method according to the present invention;

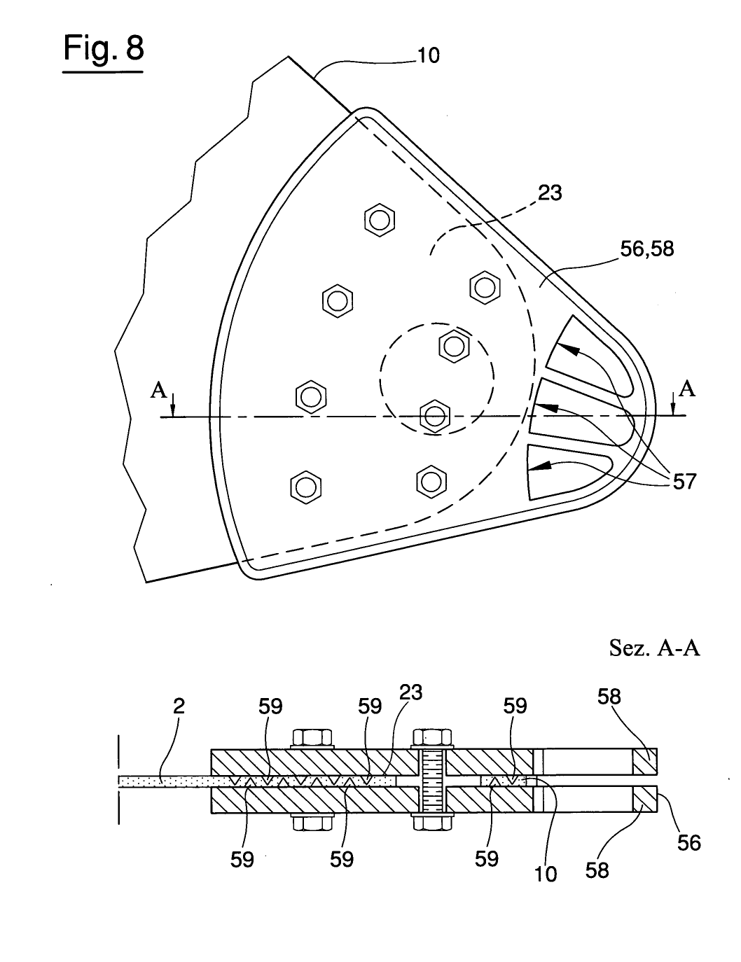

FIG. 8 is a view in enlarged scale and with some parts removed for clarity of an angular portion of FIG. 7;

FIG. 9 is a view of a portion of FIG. 1 sectioned according to the line IX-IX of FIG. 1 and illustrated in enlarged scale and with some parts removed for the sake of clarity;

FIG. 10 is a plan view partly in sight and partly in section of a particular extracted from FIG. 1;

FIG. 11 is a schematic perspective view of a portion of FIG. 1 shown with some parts removed for clarity in a third operative step of the method according to the present invention; and

FIG. 12 is a plan view of a portion of FIG. 1 in a fourth operative step.

### DETAILED DESCRIPTION OF THE PRESENT INVENTION

In FIG. 1, the reference number 1 indicates, in its entirety, a plant for the application of a method for producing flexible membrane bodies 10 that are able to assume a given shape under load, in such a way as to constitute, for example, an awning for civil uses, sometimes briefly called tensile structure, or the wing profile of a sail, usable for the propulsion of a boat or of an aircraft.

In any case, for the sake of convenience, and in order not to limit the scope of the present invention, the steps of the method are illustrated in the accompanying drawings with reference to the manufacturing cycle of a sail. Also for the sake of convenience, the reference numbers used with reference to the sail are the same employed with reference to the generic membrane body 10. The application of tension to the membrane bodies 10 when they are in place stretches their respective outer faces 17 and prevents the collection and stagnation of rainwater in the case of awnings, and optimises their aerodynamic efficiency in the case of wing profiles. Each membrane body 10 can be produced starting from basic sheets 9 made of plastic panels cut according to given lines to locate the so-called “fullness” of the respective membrane body 10 in given areas and hence to provide the membrane body with the desired profile. These sheets 9 are preferably, but without limitation, made of polyester, as in the case of Mylard produced by the Dupont Company, and they are coupled in pairs on respective transversal edges 9′ to produce a single laminar body 12 with given shape, which develops transversely to the edges; the laminar body 12 will be subsequently covered by a plurality of covering sheets, each of which is substantially identical to a respective base sheet 9 and therefore is always indicated with the same reference number 9; each covering sheet 9 copies the perimeter of the corresponding base sheet 9, is preferably made of polyester and it is connected stably thereto through an adhesive layer 14 applied between the respective inner faces 16 of the base and covering sheets 9 to produce a semi-manufactured product 2 wherefrom the membrane body 10 can be produced.

It should be specified that here and below, with reference to the description of the production method and/or of the plant 1 or of respective equipment, the terms membrane body 10 or semi-manufactured product 2 will be used as required by the context. Therefore, the elements and the related reference numbers used hitherto for the membrane body 10 are considered valid also to distinguish dual elements of the semi-manufactured product 2. On the other hand, it is readily apparent that the use of the term “membrane body” 10 in an intermediate step of the method shall be interpreted as semi-manufactured product 2, given that the membrane body 10 is the final product of the application of the method described hereafter. Moreover, it should be specified that in sea-faring terms, the term “fullness” defines the distance or camber between the cord and the segment detached on a membrane body 10 between two points of the membrane body 10. By analogy with the sail sector, each pair of base and covering sheets 9 coupled to each other in an adhesive manner shall, here and below, be called sailcloth 15 for the sake of convenience, although in the case of the membrane bodies 10 in question nothing structural may correspond to this term.

The better to withstand tensions in place, each membrane body 10 comprises at least one cable 20 housed along a given track 100 between the faces 16 opposite and connected to each other in an adhesive manner of pairs of base sheets 9 of each sailcloth 15 to maintain, in use, each sailcloth 15 substantially tension-free. It should be noted that each track 100 represents a line along which, in use, the traction force that stresses the membrane body 10 acts and that each cable 20 is free to slide relative to each sailcloth 15 since it is retained between the faces 16 within a sheath 22 in a manner similar to the operation of Bowden cables. Each sheath 22 is produced with an external tubular portion of the respective cable 20 during a die casting step that shall be better described below and determines, contextually, the adhesive connection of the opposing sheets 9 of each sailcloth 15. The incorporation of cables 20 enables to produce each individual sailcloth 15 using the laminar material of minimum thickness, and hence to obtain membrane bodies 10, whose mass is consequently reduced. An example of a membrane body 10 is described in the aforementioned patent application RA2004A000004, whose teachings are considered incorporated herein for the sake of simplicity. The plant 1 comprises a die casting device 30 visible in FIGS. 4, 5, 6, 7, 10 and 11. This device 30 can be used to execute some productive steps of a portion 11 of the semi-manufactured product 2 of the membrane body 10, and it presents limited extension, as shown in FIGS. 2, 4, 7 and 11 only. The portion 11 may present different extension and be more or less extended. For example, it may comprise a portion of a sailcloth 15 or even portions of two or more sailcloths 15 set side by side. The device 30 comprises a pair of presser bodies 32 that are made of a flexible and heat permeable material to be able to be applied locally to each portion 11 of the membrane body 10 in matching contact to determine, in use, an openable sandwich structure 19, visible in FIGS. 5 and 11, which is thus a part of the device 30, as shall be further clarified below. Moreover, again with reference to FIG. 1, the plant 1 comprises a device 40 for the delivery of heat/thermal activation that presents at least one radiating plate 41 which can be activated electrically to deliver heat to a portion 11 of given extension maintained under vacuum between two presser bodies 32, and hence usable to activate the adhesive layer 14 positioned between two faces 16 facing each other. The activation device 40 comprises a control unit 43 connected electrically to the plate 41 and adapted to provide instant by instant heat at a given temperature to the portion of given extension according to a given thermal cycle, which comprises a succession of heating and cooling controlled as a function of time, for example but without limitation according to the type of adhesive used for the preparation of the layers 14. In this regard, the control unit 43 is provided with a feedback control circuit 44, known and therefore not shown herein, whose operation is made possible by means of a plurality of respective temperature sensors 45, able to provide instant by instant the local value of the temperature of each presser body 32, and hence of the portion 11 whereto, in use, heat is delivered. In this regard, some sensors 45 may be applied indifferently to the plates 41 or to the body 32 which is placed in contact with at least one plate 41, and other sensors 45 shall be applied to the other body 32, in such a way as to enable to reconstruct the trend of the thermal gradient within the membrane body 10 being processed, given the knowledge obtainable from design data of the assembly that comprises the two presser bodies 32 and the portion 11 of membrane body 10 maintained between them.

As shown in FIGS. 9 and 10, each plate 41 is adapted to deliver heat at a homogeneous temperature over the entire respective extension and it enables to obtain this result through the combination of a grid 46 of conductive material kept isolated from the floor by a layer 48 of insulating material, and covered by a foil 49 of metallic material with low thermal inertia, for example, although without limitation, aluminium or an alloy thereof The device 40 is able to co-operate with at least one body 32 to determine a heat adhesion between the mutually opposite faces 16 of each pair of sheets 9 and the formation of the sheaths 22 with an external tubular portion of each cable 20, produced using, preferably but without limitation, rowing 101 of free fibres. To each body 32 is associated at least one aspirating element 34 whereby it is possible to aspirate air from a gap 5 between the portion of given extension of the membrane body 10 and each body 32, to determine the adhesion between the mutually facing faces 16 of each pair of sheets 9/sailcloth 15, and to enable to dose the value of the pressure acting transversely of each portion 11 during the die casting operation, exploiting the flexibility of the presser body 32 itself. Naturally, the density per unit of surface of aspirating elements 34 shall be calibrated in relation to requirements, and in particular to the rate of vacuum, and hence of pressure to be applied to the faces 17 of the semi-manufactured product 2.

The plant 1 further comprises a loading device 50 able to reproduce a tension model similar to the one that, in operation, acts at least on the portion 11, as shown in FIG. 4. In this regard, this device 50 comprises traction elements 52 provided in association with lateral edges 18 of the portion 11 of given extension to be treated with die casting in order to keep it stretched with the expected distribution of fullness, i.e. free of creases to obtain the effects described above in such a way as to simulate an operating condition for the portion 11. In FIG. 4, for the sake of simplicity of representation, said traction elements 52 are illustrated schematically through the respective traction lines that act in opposite senses on mutually orthogonal directions. The availability of the loading device 50 and of the elements 52 enables to couple the bodies 32 to the faces 17 in a mating manner and to obtain the direct transmission of heat from the plates 41 to the involved portion of the semi-manufactured product 2 to obtain the complete activation of the layer 14 between the sheets 9 and the formation of the sheaths 22. In practice, the elements 52 may be embodied by cables made of textile fibre which shall in any case be designated by the same reference number 52.

Naturally, what is described above finds valid application also if the extension of the portion 11 is such as to completely include the membrane body 10 itself. In this case, the same reference numbers will be used to indicate devices, members and elements of the membrane 10 already employed and also those already mentioned with reference to the portion 11 described above. The delivery of heat to each presser body 32 can take place by conduction once one of the two presser bodies 32 that cover the portion 11 is placed in contact with at least one plate 41. In view of the above description, only one outer face of the portion 11, or of the membrane body 10 as needed, faces a plate 41, hence the source of heat that induces the activation of the adhesive layer 14. The need to follow the shape of the membrane body 10 by the bodies 32 could determine undulations of the sandwich structure comprising the two presser bodies 32 and the portion 11 covered thereby if the latter were very extensive, because of the coupling of the same portion 11 provided with the related “fullness” with flexible but planar pressers. In this case, the die casting temperature could have spotted patterns, whereto would correspond different qualities of the die casting operation itself. To obtain a homogeneous quality of the die casting in each point of the membrane body 10 and a complete formation of the sheaths 22, the die casting device 30 comprises a coating body 38, shown only in FIG. 12 and obtainable with a sheet produced with material having high insulating capacity. This body 38, therefore, is flexible to cover the undulations of the sandwich structure 19 in substantially mating manner by gravity. This prevents an excessive temperature gradient between the outer faces 17 of the semi-manufactured product 2/of the membrane body 10, and it prevents the temperature difference from exceeding a given value that approximates 5° C.÷10° C. It should be specified that the coating body 38 could comprise internally a plurality of electrical resistors, known and therefore not shown, to be electrically heated in substantially identical manner to an electric heating blanket; therefore, the body 38 can be interpreted as a device for the production of heat at given temperature, to be used in combination or alternatively to the radiating plates 41, in order to minimise, in use, the temperature gradient between two presser bodies 32 that face each other and hence the corresponding portion of the membrane body 10. In any case, the expected effect of the application of the body 38, whether or not it is complemented with a device for producing heat, will be to minimise the differences between the external temperatures of the bodies 32 positioned at opposite sides of a same portion 11 within 5° C.÷10° C.

Obviously, the method described above can also be used to rework portions 11 of the membrane body 10 whose sheets are locally detached at the end of the heating operation or as a result of even limited use.

It is also evident that, if the portion 11 extends substantially as much as the entire membrane body 10, each body 32 will have to present sufficiently extensive dimensions to cover all the sailcloths 15 of the membrane body 10 itself. In such cases it may be convenient to connect the bodies 32 on respective sides 33 with adequate extension to define a pouch body 36, visible in FIGS. 6 and 7, associated to the device 30 and adapted integrally to house within its interior a membrane body 10; therefore, the body 36 is able completely to cover each of the mutually opposite faces 17 that delimit the membrane body 10. This also simplifies the formation of the sandwich structure 19 thanks to the greater ease with which a depression/a pneumatic vacuum can be produced between an inner body of the body 36, or of the body 32, and the corresponding portion of membrane body 10 that faces it. Preferably, although without limitation, it may be convenient to use strips 37 of repositionable adhesive tape to hermetically close the sides 33 of the presser bodies 32 left open by the insertion of the semi-manufactured product 2 to be subjected to die casting. This would enable completely to isolate from the exterior said semi-manufactured product 2 housed within the body 36 and to make the body 36 indefinitely reusable.

If should be specified that the load device 50 also comprises uprights 54 with height adjustable at will to allow the detachment from the ground, by lifting, of a membrane body 10 through at least one cable 52. In this regard, each upright 54 is provided with at least one pulley 55 in a respective free end for a cable 52 and it can be associated to a retrieval device 53 for the excess segment of the cable 52. The device 50 further comprises engagement members 56 each of which is so shaped as to grip the clews/angular portions 23 of the membrane body 10, and it is provided with at least one eyelet 57 engageable by a cable 52 for the application of the traction, and hence lifting load, to be applied to the membrane body 10 to cause a sort of stretching of the semi-manufactured product 2. Each member 56 presents two jaws 58 that are mutually connected through threaded members to establish a rigid contact with the respective clew 23 and they internally present projections 59 able superficially to indent the material/the skin of each laminar body 12 to stabilise the grip of the respective clew 23 and hence the position of the eyelet 57 during the application of the load through the cables 52.

The application of the load enables to stretch any creases of the semi-manufactured product 2 within the pouch body 36 and, in view of the above description, it can be accomplished through the device 50 in an equipped space with limited height and extension under the simple action of gravity. During this step of stretching the semi-manufactured product 2, each body 34 is used to produce vacuum, in such a way as to refer in stable manner the pouch body 36 with respect to the semi-manufactured product 2 and to ready the body 36 itself to the application of the desired pressure on the semi-manufactured product 2. Once the semi-manufactured product 2 is completely stretched within the respective body 36 through the traction exerted by the cables 52, the stably connected assembly of the completely stretched semi-manufactured product 2 and of the pouch body 36 that keeps it tight between two respective spacer bodies 39 may be lowered above the plates 41 to proceed with the delivery of the heat necessary to activate the adhesive layer 14.

Therefore, the, device 50 for loading the plant 1 can easily be set up inside an industrial shed of average dimensions and with affordable costs even for small enterprises. In addition, it should be specified that this solution enables to apply to the semi-manufactured product 2 a tension that is well below its breaking tension, and hence to preserve its physical integrity at every step of the production cycle, since the tension whereto the respective peripheral sides are subjected to assure the flattening of the surfaces 17 of the membrane body 10 is markedly lower than the operating tension.

The plant 1, moreover, comprises an aspirating unit 60 coupled in a fluid-tight manner with each aspirating member 34 to generate, in use, a vacuum between each sheet 9 and each respective presser body 32 or pouch body 36. In particular, each presser body 32/pouch body 36 is externally delimited by an air-impermeable coating 31 and it is provided internally with the spacer body 39 which is flexible to take mating contact with the membrane body 10 and to maintain a gap 5 of minimum thickness between the impermeable coating 31 and the portion 11 or the membrane body 10, based on the extension of the portion of layer 14 of adhesive to be subjected to die casting. As is readily apparent, the gap 5 is completely engaged by the body 39, which is made of felt or of another structurally similar material, and hence porous, to present sufficient height to maintain, in use, the aspirating members 34 in aerial communication with the interior of each body 32, in addition to allow relative movements between the membrane body 10 and the pouch body 36, which may be necessary for stretching the surfaces 17 before the full activation of the aspirating device 60, and for aspirating the residual air. It should be noted that, again according to FIG. 1, the plant 1 comprises an electronic computer 70 whereto are connected the aspirating unit 60, the temperature sensors 45 and the control unit 43 to globally oversee the operating modes of the plant 1.

Use of the plant 1 will be more readily apparent from the description that follows, from which it will be possibly punctually to deduce the steps of the method for the production of a membrane body to be used as wing profile and hence of a sail 10.

For the sake of brevity, the steps of the method 20 in question are illustrated starting from the step in which the semi-manufactured product 2 has already been completed.

At this point, the semi-manufactured product 2 is locally or integrally subjected to the die casting step by application of a constant pressure on its own faces 17 and hence on a portion 11 of given extension either on its entire surface through pairs of presser bodies 32, or through the entire pouch body 36, through the openable/temporary sandwich structure 19, and for the simultaneous delivery of heat 5, necessary for the activation of the layer 14. If the die casting has to be limited to a portion 11 of given extension of the semi-manufactured product 2, the application of tension may be limited only to the portion 11 involved, in order to stretch it perfectly, respecting the spatial distribution of its fullness in order to provide the portion 11 with substantially identical shape to the one it will have when installed; any creases are eliminated from the two bodies 32 and adhesive strips 37 are applied to the edges of the bodies 32 to connect them stably and in an air-tight manner to the respective faces 17 in such a way as to stabilise the openable sandwich structure which comprises two bodies 32 and the portion 11 included between them. Subsequently a body 32 is locally applied which approximates by excess the extension of the portion 11 to be treated on each of the respective outer faces 17. At this point, air is aspirated through each aspirating member 34 of each body 32 through the aspirating unit 60 until determining the application of a substantially homogeneous pressure on the two faces 17 of the portion 11. The next production step is to cause the activation of the adhesive layer 14 in such a way as to determine the permanent connection of the two laminar bodies 12 at the portion 11 and at the sheaths 22 with an external tubular portion of each rowing 101 of free fibres, and in particular with the portion imbibed with adhesive of the layer 14 which, for clarity of representation, in FIG. 3 is shown separated- from the free fibres by a dashed and dotted line indicated by the letter L. The delivery of heat is executed activating as many plates 41 as are required by the extension of the portion 11 and hence it is necessary to position the portion 11 above each of these plates 41 which will be brought to temperature according to a thermal cycle set through the control unit 43. If the temperature gradient between the two bodies 32 has to be minimised below a given temperature, the upper body 32, opposite to the one placed in contact with the plate 41, should be covered completely with a coating body 38 with greater extension than the portion 11 itself for heat insulation according to the procedures described above. Naturally, the heat delivery step may be associated to the step of aspirating air from the gaps 5. The unit 60 may be controlled with feedback to measure with continuity the value of pressure within the gaps 5. This will allow to provide operators with information on the way the die casting operation proceeds, in order to enable them to decide whether to continue it and whether, the value of the vacuum remaining outside an optimal range for the type of adhesive used for the layer 14, the operation should be continued or executed anew, e.g. after remedying any detachments of the strips 37, or the replacement of at least one of the bodies 32, e.g. because of the loss of continuity of its coating 31 impermeable to air. Naturally, if the portion 11 coincides with the semi-manufactured product 2, it would be easy to use the pouch body 36 described above, and operate similarly to the above description. It is certain that it could be less easy to stretch the semi-manufactured product 2 within the body 36 if the semi-manufactured product 2 is very large. In this case, the application of the vacuum through the unit 60 is preceded by a step of lifting by the respective ends the semi-manufactured product 2, already contained by the body 36 not yet sealed and maintained at lower than atmospheric pressure, through the cables 52 borne/transmitted by the uprights 54 of the loading device 50 and connected securely to end portions of the semi-manufactured product 2 provided with the appropriate eyelets, exploiting the force of gravity to provide the semi-manufactured product 2 with the shape that the sail 10/the membrane body 10 originated by the die casting operation shall assume when installed. The subsequent hermetic closure of the pouch body 36, and the fact that each respective body 32 is flexible, will enable to bring in mating contact the inner face of the corresponding spacer body 39 with the respective laminar body 12 to allow maintaining a gap 5 between the impermeable coating 31 and the portion 11/the membrane body 10 to be laminated. In this case as well, the pressure decrease will have to take place slowly through the unit 60, to enable operators to intervene to stretch locally any creases of the bodies 32 on the semi-manufactured product 2. If the portion 11 coincides with the semi-manufactured product 2, it will be necessary to have available a furnace 47 comprising a continuous distribution of plates 41 and a coating body 38 of adequate dimensions, but this would not represent a variant of what is described above with reference to a portion 11 of limited extension.

Once the value of the vacuum is equal to the desired one, the membrane body may be lowered onto the plates 41 of the furnace 47, and to deliver heat to the presser bodies 32/to the pouch body 36 to perform the static die casting of the semi-manufactured product 2/membrane body 10, which will be kept at a given value of pressure and value of temperature for an adequate time interval, and subsequently cooled in a controlled manner to optimise the characteristics of the gluing and maximise the quality of the membrane body 10.

Lastly, it is readily apparent that the plant 1 and the method that can be implemented through said plant, and the accessories of the plant itself, can be subjected to modifications without however departing from the protective scope of the present invention.

For example, in the case of particularly important application, one may think of using pouch bodies 36 shaped like the membrane body 10 that has to be housed thereby for the die casting operation. Consistently with said approach, one could think of defining a radiant surface with sufficient extension and/or conformation to replicate substantially in negative form the dimension and/or the shape that shall be attributed to the membrane body 10 by coupling a plurality of plates 41 laterally to each other.

In any case, the set of the plates 41 can be interpreted as a sort of open furnace 47 able to house the pouch body 36 in order to subject the membrane body 10 to die casting treatment in association with the aspirating unit 60.

In view of the above description, it is readily apparent that implementation of the method through the plant 1 enables to produce membrane bodies 10 at very low energy consumption levels and production times, employing a minimum number of human resources with ordinary specialisation and through a particularly simple and economical plant. In particular, it should be noted that the prior art contains no teachings that would suggest using static die casting on a horizontal plane 13 to produce flexible membrane bodies through an openable sandwich structure 19. On the other hand, it makes no difference whether the die casting step takes occurs statically on the furnace 47 itself through the use of a sandwich structure 19 with limited extension or otherwise relative to the dimension of the membrane body 10, provided that one operates on a plane 42 comprising at least one of the planar plates 41 and thermally insulated in a very simple and economical manner through the simple coverage by gravity of a flexible body 38. In view of the above description, it is also possible to perform die casting treatments on portions 11 delimited by triangular perimeters, and anyway on two-dimensional segments presenting dimensions that, measured along respectively perpendicular directions, present lengths of the same order of magnitude, contrary to what takes place in rolling mills.

Therefore, it will not be surprising that through the implementation of the method and the plant 1 illustrated above it is possible to produce membrane bodies 10 with low cost but high performance characteristics and reduced mass.

1. A method for the production of a membrane body (10) that is flexible and able to assume a given shape under load; said membrane body being provided with at least one pair of flexible sheets (9) mutually coupled through an adhesive layer (14); said membrane body (10) comprising at least one cable (20) housed within a sheath (22) positioned between the respective said sheets (9) along a force line (100) to maintain, in use, each pair of said sheets (9) substantially free of tensions; said method comprising a step of die-casting a portion (11) of given extension of said membrane body (10) to determine adhesion between said sheets (9) and form said sheaths (22) with an external tubular portion of each said cable (20); characterised in that said step of die casting said portion (11) takes place in a static manner and comprises a step of thermally activating each said adhesive layer (14) at variable temperature in a manner adjustable at will.

2. A method as claimed in claim 1, characterised in that said die casting step is carried out statically and comprises a step of delivering heat and a step of inducing vacuum associated to said sheets (9) of said membrane body (10); said step of delivering heat being substantially simultaneous with said step of inducing vacuum.

3. A method as claimed in claim 2, characterised in that said step of delivering heat is carried out through a heat delivery device (30) provided with a sandwich structure (19) comprising a pair of presser bodies (32) able to face each other to coat said portion (11) of given extension in a mating manner; said step of delivering heat being preceded by a step of locally applying said pair of presser bodies (32) to said portion (11) of given extension in a mating manner.

4. A method as claimed in claim 3, characterised in that said step of thermally activating said adhesive layer (14) is preceded by a step of determining said mating contact by inducing vacuum between said portion (11) of given extension and each said presser body (32).

5. A method as claimed in claim 3, characterised in that to said step of locally applying said pair of presser bodies (32) in a mating manner is associated a step of applying tension to said portion (11) of given extension to stretch any creases.

6. A method as claimed in claim 5, characterised in that said portion (11) of given extension is shaped according to a predetermined conformation that substantially coincides with a shape that can be assumed in use by said portion (11) of given extension.

7. A method as claimed in claim 4, characterised in that said step of determining said mating contact by inducing vacuum comprises a step of removing air between each said presser body (23) and said membrane body (10).

8. A method as claimed in claim 3, characterised in that said step of thermally activating said adhesive layer (14) to determine adhesion between each pair of said sheets (9) is associated to a step of delivering heat to said portion (11) of given extension through at least one respective said presser body (32) applied locally to said portion (11) of given extension.

9. A method as claimed in claim 3, characterised in that said step of delivering heat to said portion (11) of given extension comprises a step of positioning a first said presser body (32) applied locally to said portion (11) of given extension in contact with a radiating body (41) and a step of delivering heat at a controlled temperature through each said radiating body (41) in such a way as to subject said portion (11) of given extension to a given heat cycle.

10. A method as claimed in claim 9, characterised in that said step of placing a first said presser body (32) applied locally to said portion (11) of given extension in contact with a radiating body (41) is followed by a step of completely covering said second presser body (32) applied locally to said portion (11) of given extension at opposite side from said first presser body (32) with a coating body (38) to contain external temperature differences of said first and second presser bodies (32) with a coating body (38) to contain external temperature differences of said first and second presser bodies (3) within 5° C.÷10° C.

11. A method as claimed in claim 10, characterised in that said coating body (38) comprises a sheet or other material with high insulating power and flexible to coat by gravity said sandwich structure (19) following its respective undulation in substantially mating manner.

12. A method as claimed in claim 5, characterised in that said portion (11) of given extension entirely comprises said membrane body (10).

13. A method as claimed in claim 3, characterised in that each said presser body (32) is geometrically shaped to cover said membrane body (10) entirely.

14. A method as claimed in claim 12, characterised in that said step of locally applying a pair of said presser bodies (32) to said portion (11) of given extension in a mating manner comprises a step of inserting said membrane body (10) into a pouch body (36) comprising a plurality of said presser bodies (32) and closed on respective edges (3) in a repositionable adhesive manner.

15. A method as claimed in claim 14, characterised in that to said step of applying tension to said portion (11) of given extension is associated a step of subjecting to tension the entire said membrane body (10) to stretch any creases.

16. A method as claimed in claim 15, characterised in that said step of subjecting to tension the entire said membrane body (10) comprises the step of applying cables (52) to end portions (23) of said membrane body (10).

17. A method as claimed in claim 15, characterised in that said step of subjecting to tension the entire said membrane body (10) comprises a step of hanging the entire said pouch body (36) in such a way as to maintain it completely raised off the ground.

18. A method as claimed in claim 3, characterised in that said heat delivery device (30) is provided with a plate (41) adapted to house said sandwich structure (19) in a substantially mating manner.

19. A method as claimed in claim 3, characterised in that said heat delivery device (30) comprises a furnace (47) provided with a plurality of plates (41) for housing said sandwich structure (19) in a substantially mating manner.

20. A method as claimed in claim 17, characterised in that said pouch body (36) presents extension that approximates by excess the extension of said membrane body (10).

21. A method as claimed in claim 20, characterised in that each said plate (41) is shaped similarly to said membrane body (10) when in place.

22. A plant for the production of a flexible membrane body (10); said membrane body (10) comprising at least one pair of flexible sheets (9) facing each other and coupled through an adhesive layer (14); said membrane body (10) comprising at least one cable (20) housed within a sheath (22) positioned between the respective said sheets (9) along a force line (100) to maintain, in use, each pair of said sheets (9) substantially free of tensions; characterised by comprising die casting means (30) able to be interfaced to at least one portion (11) of given extension of said membrane body to determine adhesion between said pair of said sheets (9) and form said sheaths (22) with an external tubular portion of each said cable (20).

23. A plant as claimed in claim 22, characterised in that said die casting means (30) comprise a delivery device (40) able to provide heat to said adhesive layer (14) in such a way as to activate it thermally in a static manner and a vacuum induction device (60) able to act on portions of membrane body (10) delimited by sides whose dimensions are of the same order of magnitude.

24. A plant as claimed in claim 23, characterised in that said die casting means (30) comprise, in use, a sandwich structure (19); said sandwich structure comprising said portion (11) of given extension and a pair of presser bodies (32) applicable locally to said portion (11) of given extension in a mating manner.

25. A plant as claimed in claim 24, characterised in that each said presser body (32) is made of flexible material and in that to said die casting means (30) are associated aspirating means able to produce pneumatic vacuum between said portion (11) of given extension and each said presser body (32) to determine said mating contact between said portion (11) of given extension and each said presser body (32).

26. A plant as claimed in claim 25, characterised in that each said presser body (32) is provided with at least one aspirating element (34) connected in an air-tight manner to said aspirating means able to produce in association with said vacuum inducing device (60) pneumatic vacuum between said portion (11) of given extension and said presser body (32) itself, to determine the adhesion between the corresponding said sheets (9) and dose the value of a pressure acting transversely on each portion (11) of given extension during the die casting operation exploiting the flexibility of the presser body (32).

27. A plant as claimed in claim 22, characterised by comprising means (50) for applying tension able to act on said portion (11) of given extension to provide said portion (11) of given extension with its own predetermined conformation.

28. A plant as claimed in claim 24, characterised in that each said presser body (32) is permeable to heat to transmit, in use, the heat transmitted by said delivery device to said portion (11) of given extension.

29. A plant as claimed in claim 28, characterised in that each said delivery device (40) comprises at least one radiating element (41) able to transmit heat in use to each said presser body (32) of said openable sandwich structure (19); control means (43) being provided in association to each said radiating element (41) to provide instant by instant heat at a given temperature to said sandwich structure (19).

30. A plant as claimed in claim 29, characterised in that each said radiating element (41) comprises a plate (41) provided with a grid (46) of conductive material maintained isolated from a floor through a layer (48) of insulating material, and covered by at least one foil (49) made of metallic material with low thermal inertia.

31. A plant as claimed in claim 30, characterised in that each said foil (49) is made of aluminium or an alloy thereof.

32. A plant as claimed in claim 31, characterised in that said control means (43) are adapted to vary said given temperature according to a given thermal cycle.

33. Plant as claimed in claim 31, characterised in that said control means (43) comprise a feedback control circuit (44) comprising a plurality of respective temperature sensors (45), able to provide instant by instant the local value of a temperature of each said presser body (32).

34. A plant as claimed in claim 29, characterised in that each said plate (41) is substantially planar.

35. A plant as claimed in claim 29, characterised in that said plate (41) is so shaped as to reproduce in negative form the shape under load of at least one portion (11) of given extension of said membrane body (10).

36. A plant as claimed in claim 33, characterised in that said delivery device (40) comprises a furnace (47) provided with a plurality of said plates (41).

37. A plant as claimed in claim 24, characterised in that said die casting means comprise a coating body (38) able to interface, in use, at least one of said presser bodies (32) applied locally to said portion (11) of given extension to contain differences in external temperature between said presser bodies (32) within 5° C÷10° C.

38. A plant as claimed in claim 37, characterised in that said coating body (38) can be heated electrically.

39. A plant as claimed in claim 24, characterised in that each said presser body (32) comprises a spacer element (39) able to take mating contact with said membrane body (10) underneath a respective said presser body (32) to produce a gap (5) sufficient to allow relative movements between said presser body (32) and said membrane body (10).

40. A plant as claimed in claim 24, characterised in that each said presser body (32) is delimited externally by a coating (31) impermeable to air.

41. A plant as claimed in claim 22, characterised in that said portion (11) of given extension entirely comprises said membrane body (10).

42. A plant as claimed in claim 41, characterised in that said die casting means (30) comprise a pouch body (36) provided with a plurality of said presser bodies (32) and hermetically closed through repositionable adhesive strips (37); said pouch body (36) having sufficient dimensions to house said membrane body (10) entirely.

43. A plant as claimed in claim 41, characterised in that said means (50) for applying tension comprise cables (52) applicable to said membrane body (10) and at least one upright (54) adapted to lift said membrane body (10) completely through said cables (52).

44. A plant as claimed in claim 43, characterised in that said means (50) for applying tension comprise at least one engagement member (56) shaped to grip angularly said membrane body (10) and engageable by a said cable (52) for said application of tension.

45. A plant as claimed in claim 44, characterised in that each said engagement member (56) presents two jaws (58) mutually connected through threaded members to establish a rigid contact with said membrane body (10) and, in use, stabilise the position of said eyelet (57) during the application of load through said cables (52).

46. A pouch body (36) for producing a membrane body (10), characterised by comprising at least two presser bodies (32) mutually connected stably in fluid-tight adhesive repositionable manner at respective lateral edges (33).

47. A pouch body as claimed in claim 46, characterised in that each said presser body (32) is delimited exteriorly by a coating (31) impermeable to air and presents internally a spacer element (39) able to take mating contact with said membrane body (10) to determine a gap (5) between said coating (31) impermeable to air and said membrane body (10) sufficient to allow relative movements between said presser bodies (32) and said membrane body (10).

48. A pouch body as claimed in claim 47, characterised by comprising a plurality of air aspirating inlets (34) communicating with said gap (5).

49. A pouch body as claimed in claim 47, characterised in that said spacer element (39) comprises a layer of material that presents mechanical characteristics similar to felt.

50. A pouch body as claimed in claim 46, characterised in that the respective said presser bodies (32) are so conformed as to reproduce the shape of at least one portion (11) of given extension of said membrane body (10).

51. A pouch body as claimed in claim 46, characterised in that the respective said presser bodies (32) are so conformed as to reproduce the shape of said membrane body (10).

52. An engagement member (56) usable to produce a membrane body (10), characterised by being so shaped as to grip angularly said membrane body (10) and by being provided with at least one eyelet (57) engageable by a cable (52) for the application of traction load.

53. An engagement member as claimed in claim 52, characterised by presenting two jaws (58) mutually connected through threaded members to establish a rigid contact with said membrane body (10) and, in use, stabilise the position of said eyelet (57) during the application of load through said cables (52).

54. A furnace (47) usable to produce a membrane body (10), characterised by comprising a plurality of radiating members (41) set side by side to define a substantially planar radiating surface able to house said sandwich structure (19) in a substantially mating manner.

55. A furnace as claimed in claim 54, characterised in that said radiating members (41) are able to deliver heat at a given temperature; control means (43) being provided in association to each said radiating member (41) to provide instant by instant heat at a given temperature to said sandwich structure (19).

56. A furnace as claimed in claim 55, characterised in that each said radiating member (41) comprises a plate (41) provided with a grid (48) of conductive material maintained isolated from a floor through a layer (48) of insulating material, and covered by at least one foil made of metallic material with low thermal inertia.

57. A furnace as claimed in claim 56, characterised in that each said foil (49) is made of aluminium or an alloy thereof.

58. A furnace as claimed in claim 57, characterised in that said control means (43) are adapted to vary said given temperature according to a given thermal cycle.

59. A furnace as claimed in claim 57, characterised in that said control means (43) comprise a feedback control circuit (44) comprising a plurality of respective temperature sensors (45), able to provide instant by instant the local value of a temperature of each said presser body (32).

60. A sail, characterised by comprising a membrane body (10).

61. An awning for civil uses, characterised by comprising a membrane body (10).
